(19) United States
(12) Patent Application Publication
(10) Pub. No.: US 2013/0039688 A1
(43) Pub. Date: Feb. 14, 2013

(54) PAINT TOOL FOR MANUALLY SUPPLYING DYE

(71) Applicant: Cheng-Wei Su, Taichung (TW)

(72) Inventor: Cheng-Wei Su, Taichung (TW)

(21) Appl. No.: 13/370,329

(22) Filed: Feb. 10, 2012

(30) Foreign Application Priority Data
Aug. 12, 2011 (TW) 100215024

(51) Int. Cl. B05C 17/005

(52) U.S. Cl. 401/186

(57) ABSTRACT

A paint tool for manually supplying dye includes a draft container and a paint assembly. The draft container includes a flexible body, a draft head and a unidirectional gate. The draft head is fixed on the flexible body and has a locking hole. The unidirectional gate is mounted through a bottom of the flexible body. The paint assembly is assembled with the draft head and includes a rod, a connector, a channel and a brush head. When the flexible body is compressed, the paint dye flows from the locking hole into the channel to attend to the brush head for supplying the paint dye with the brush head. When the flexible body is released, the air is sucked into the flexible body via the unidirectional gate to prevent the paint dye from leaking.

### BACKGROUND OF THE INVENTION

1. Field of the Invention

The present invention relates to a paint tool, and more particularly to a paint tool for manually supplying dye.

2. Description of Related Art

A conventional painting tool includes a paint can for storing paint dye and a paintbrush. A user might put the paint into the paint can, soak the paintbrush in paint dye and paint on the object.

However, the object sometimes is located at a higher place. The user needs to climb a ladder for painting the object. The soaked paint dye carried by the paintbrush is limited, and the space on the ladder is not enough to place the paint can. The user has to climb the ladder up and down for painting and re-soaking the paintbrush, and accidents would happen during the climbing process, which is inconvenient. If the size of the paint can is reduced to be placed on the ladder or be carried by the user, the frequency of climbing ladder can be decreased. Depending on stickiness of the paint dye, the paint dye may be dropped from the paintbrush and spot on the user's clothes. When the object is higher than the user's head, the paint dye might be dropped on the user's face.

To overcome the shortcomings, the present invention tends to provide a paint tool for manually supplying dye to mitigate or obviate the aforementioned problems.

### SUMMARY OF THE INVENTION

The main objective of the invention is to provide a paint tool for manually supplying dye that includes a draft container and a paint assembly.

The draft container has a flexible body, a draft head and a unidirectional gate. The flexible body is provided for storing paint dye and has an opening defined on a top of the flexible body. The draft head is fixed on the flexible body, covers the opening, and has a locking hole defined through the draft head and communicates with the opening. The unidirectional gate is mounted in a bottom of the flexible body, has a first end disposed inside of the flexible body and a second end protruding through the bottom of the flexible body. The unidirectional gate includes a first through hole, a second through hole, a receiving recess and a flexible valve. The first through hole is defined in the first end of the unidirectional gate. The second through hole is defined in the second end of the unidirectional gate. The receiving recess is defined in the unidirectional gate and communicates with the first through hole and the second through hole. The flexible valve is disposed in the receiving recess and is a flat tapered tube. The flexible valve has a narrow end and a broad end. The narrow end is connected with the first through hole. The broad end is opposite to the narrow end and is connected with the second through hole. The paint assembly is mounted on the draft head and has a brush set. The brush set includes a rod, a connector, a channel and a brush head. The rod has a first end and a second end. The connector is disposed on the first end of the rod and is selectively inserted into the locking hole. The channel is defined through the rod and the connector and communicates with the locking hole and the opening. The brush head is disposed on the second end of the rod and is connected with the channel. When the flexible body is compressed, the paint dye in the flexible body flows through the opening, the locking hole and the channel to the brush head. When the flexible body is released, an air pressure in the flexible body is smaller than that of an external environment such that air is sucked into the flexible body from the second through hole in the unidirectional gate via the flexible valve and the first through hole, and the narrow end of the flexible valve is connected with the second through hole for preventing the paint dye from leaking.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a paint tool for manually supplying dye in accordance with the present invention;

FIG. 2 is a perspective view of the paint tool for manually supplying dye in FIG. 1;

FIGS. 3 and 4 are cross-sectional end views of a locking hole and a connector of the paint tool for manually supplying dye in FIG. 2;

FIG. 5 is an enlarged side view in partial section of a unidirectional gate of the paint tool for manually supplying dye in FIG. 2;

FIG. 6 is an exploded operational view of the manual paint tool in FIG. 1;

FIG. 7 is an exploded perspective view of a second embodiment of the paint tool for manually supplying dye in accordance with the present invention;

FIG. 8 is an exploded operational view of the paint tool for manually supplying dye in FIG. 7; and

FIG. 9 is an exploded perspective view of a third embodiment of the paint tool for manually supplying dye in accordance with the present invention.

### DETAILED DESCRIPTION OF PREFERRED EMBODIMENT

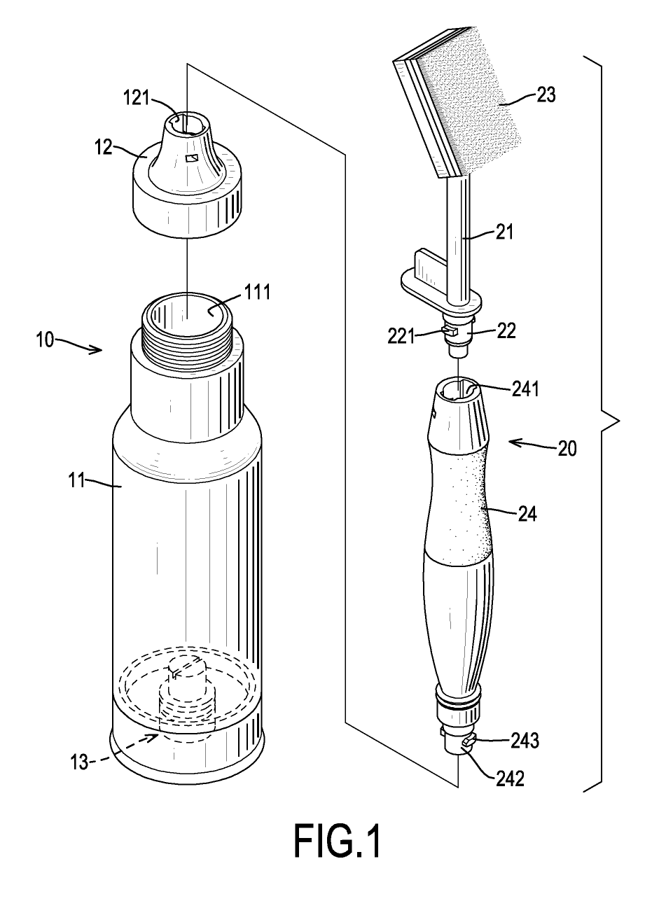

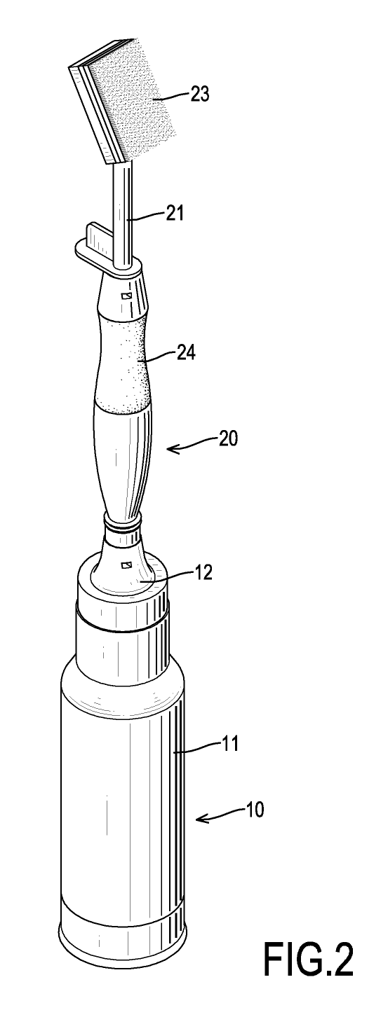

With reference to FIGS. 1 and 2, a paint tool for manually supplying dye in accordance with a first embodiment of the present invention comprises a draft container 10 and a paint assembly 20.

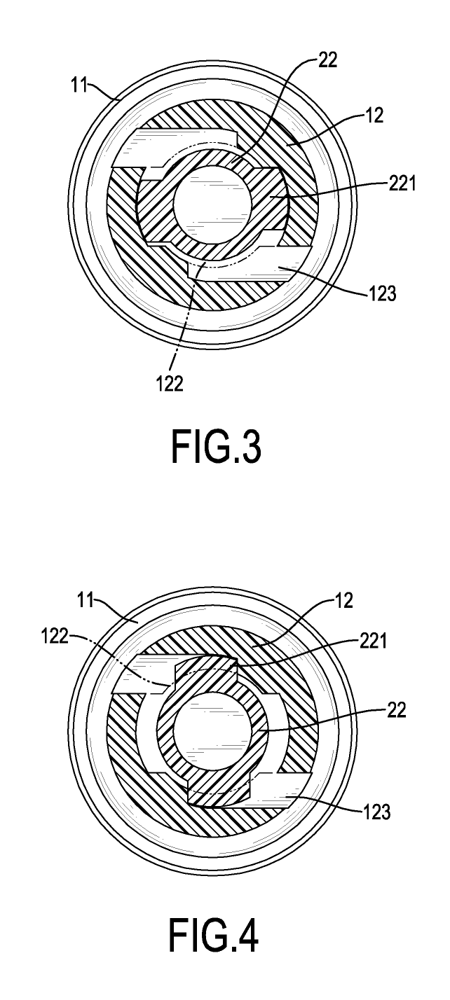

The draft container 10 includes a flexible body 11, a draft head 12 and a unidirectional gate 13. The flexible body 11 is plastic, compressible and restorative for storing paint dye. The flexible body 11 has an opening 111 defined in a top of the flexible body 11 and an air hole defined in a bottom of the flexible body 11. The draft head 12 is mounted securely on the top of the flexible body 11 and covered on the opening 111. The draft head 12 has a locking hole 121 defined through the draft head 12. With reference to FIGS. 2 and 3, the locking hole 121 includes a first transversal hole 122 and a second transversal hole 123. The first transversal hole 122 is located near a top of the draft head 12. The second transversal hole 123 is located near a bottom of the draft head 12 and communicates with the first transversal hole 122. The first transversal hole 122 has an inner space being smaller than that of the second transversal hole 123.

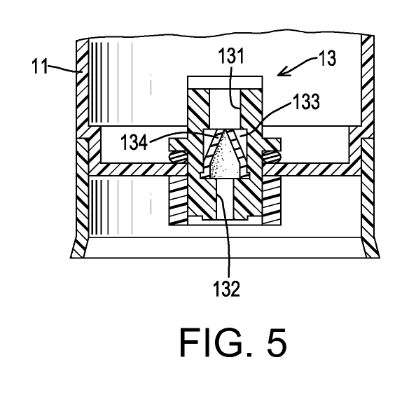

With reference to FIGS. 1 and 5, the unidirectional gate 13 is mounted in the air hole in the bottom of the flexible body 11. The unidirectional gate 13 has a first end disposed inside of the flexible body 11 and a second end protruding through the bottom of the flexible body 11. The unidirectional gate 13 has a first through hole 131, a second through hole 132, a receiving recess 133 and a flexible valve 134. The first through hole 131 is defined in the first end of the unidirectional gate 13. The second through hole 132 is defined in the second end of the unidirectional gate 13. The first through hole 131 has an inner diameter being greater than an inner diameter of the second through hole 132. The receiving recess 133 is defined in the unidirectional gate 13 and communicates with the first through hole 131 and the second through hole 132. The receiving recess 133 has an inner diameter being respectively greater than the inner diameters of the first through hole 131 and the second through hole 132. The flexible valve 134 is mounted in the receiving recess 133. The flexible valve 134 is a flat and tapered rubber tube and has a narrow end and a broad end. The narrow end of the flexible valve 134 is connected with the first through hole 131 and is elastically closed. The broad end of the flexible valve 134 is opposite to the narrow end and is connected with the second through hole 132. The broad end of the flexible valve 134 has an outer edge tightly mounted on an inner surface of the receiving recess 133 and has an inner diameter being greater than the inner diameter of the second through hole 132.

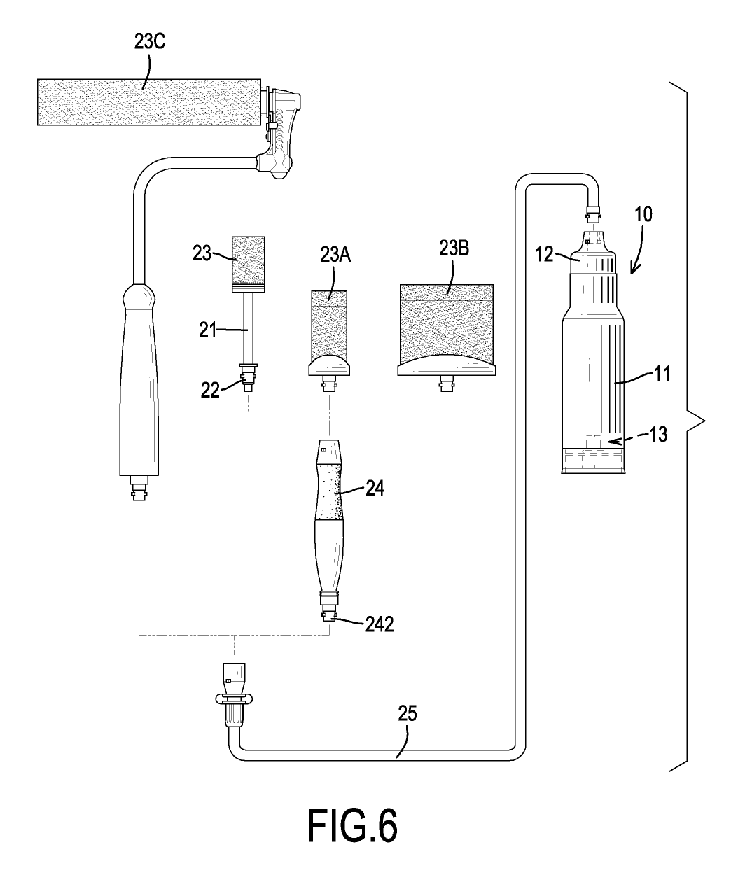

With reference to FIGS. 1 and 6, the paint assembly 20 is mounted on the locking hole 121. The paint assembly 20 includes a brush set. The brush set includes a rod 21, a connector 22, a channel and a brush head 23. The rod 21 has a first end connected to the connector 22 and a second end connected to the brush head 23. The connector 22 is cylindrical and has two protrusions 221 radially extending from the connector 22. The channel is defined through the rod 21 and the connector 22 and communicates with the brush head 23 and the connector 22. Preferably, the brush head 23 is a thin and long brush. With reference to FIG. 6, the brush head 23 can be replaced with brushes of various types, such as a flat brush 23A, a wide flat brush 23B or a rolling brush 23C for suiting the different operational requirements.

For adapting to various operational purposes, the paint assembly 20 further includes a hollow handle 24 and a connecting tube 25. The handle 24 has a first end and a second end. The first end of the handle 24 has a locking hole 241 defined in the handle 24 and being the same with the locking hole 121 in the draft head 12 for assembling with the connector 22 of the brush set. The second end of the handle 24 has a connector 242 disposed on the handle 24, being the same with the connector 22 of the rod 21 and having two protrusions 243 radially extending from the connector 242. The handle 24 also has a channel defined through the handle 24 for communicating with the locking hole 241 and the connector 242. Similarly, the connecting tube 25 has two ends. One end of the ends of the connecting tube 25 has a locking hole defined in the connecting tube 25 and being the same with the locking hole 121 of the draft head 12 for assembling with the connector 242 of the handle 24 or the connector 22 of the brush set. The other end of the ends of the connecting tube 25 has a connector disposed on the connecting tube 25 and being the same with the connector 22 of the brush set for being inserted into the locking hole 121 in the draft head 12.

When assembling, with reference to FIGS. 1, 3 and 4, the connector 242 of the handle 24 is inserted into the locking hole 121 in the draft head 12. The two protrusions 243 of the connector 242 are received in the second transversal hole 123 via the first transversal hole 122, are rotated in the second transversal hole 123 and are restricted by an inner surface of the first transversal hole 122, such that the handle 24 of the paint assembly 20 is assembled with the draft head 12 and the channel in the handle 24 communicates with the locking hole 121. Similarly, the connector 22 of the brush set is assembled with the locking hole 241 of the handle 24 in the same way. When the flexible body 11 is compressed, the paint dye in the flexible body 11 is drafted from the flexible body 11 via the locking hole 121 in the draft head 12, the channel in the handle 24 and the channel in the rod 21 to attend to the brush head 23 for easily supplying the paint dye for the brush head 23.

When the flexible body 11 is released, an air pressure in the flexible body 11 is smaller than that of an external environment, such that air is sucked into the flexible body 11 from the second through hole 132 in the unidirectional gate 13 via the flexible valve 134. When the air is sucked from the broad end of the flexible valve 134 to the narrow end of the flexible valve 134, due to the elastic rubber material of the flexible valve 134, the air pressure pushes the closed narrow end of the flexible valve 134 to be elastically opened, such that the air can flow into the first through hole 131. When the air pressure in the flexible body 11 is substantially equal to that of the external environment, based on the resilient force of the flexible valve 134, the narrow end of the flexible valve 134 is restored to be closed for preventing the paint dye in the flexible body 11 from leaking, such that the paint dye would not drop on the user's body.

With reference to FIG. 6, the connector 242 of the handle 24 can be assembled with the locking hole 121 in the connecting tube 25 and the connector of the connecting tube 25 can be assembled with the locking hole 121 in the draft head 12. The handle 24 can be assembled with a suitable brush in the same way. A user can hold the draft container 10 with one hand to supply the paint dye and hold the handle 24 of the draft container 10 with the other hand for painting.

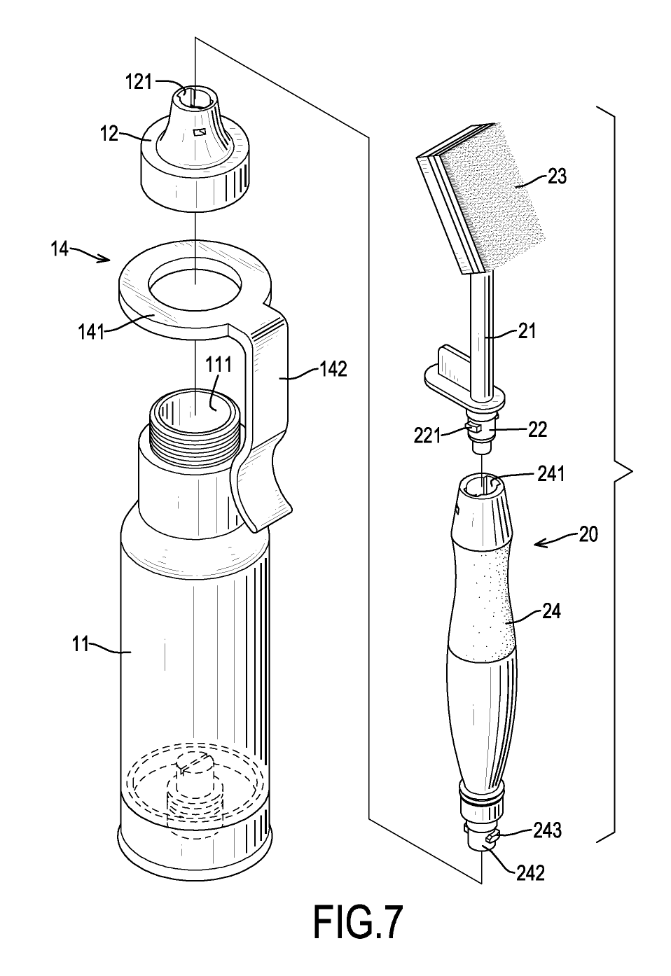

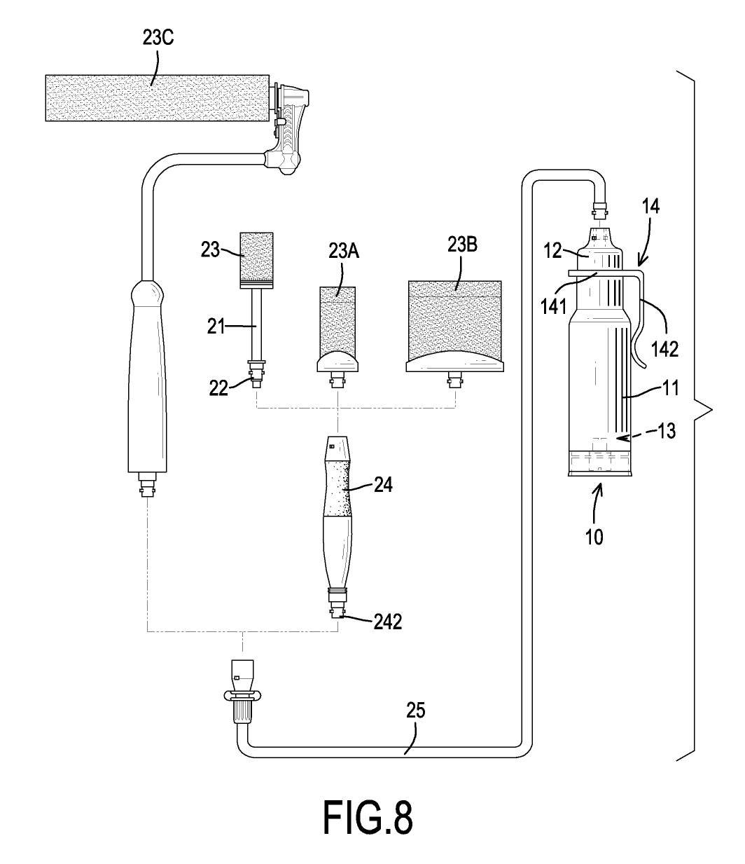

With reference to FIGS. 7 and 8, in the second embodiment of the paint tool for manually supplying dye in accordance with the present invention, the elements and effects of the second embodiment are same with those of the first embodiment except a clamper 14 mounted between the flexible body 11 and the draft head 12. The clamper 14 includes a ring 141 and a sheet 142. The ring 141 is sleeved on the flexible body 11. The sheet 142 extends from the ring 141 along an outer surface of the flexible body 11 toward the bottom of the flexible body 11. The sheet 142 is provided for being inserted into a belt of the user, such that the clamper 14 can be fixed on the waist of the user for easy carrying. Also, the user can choose a suitable brush from the brush head 23, the flat brush 23A, the wide flat brush 23B or the rolling brush 23C for painting work.

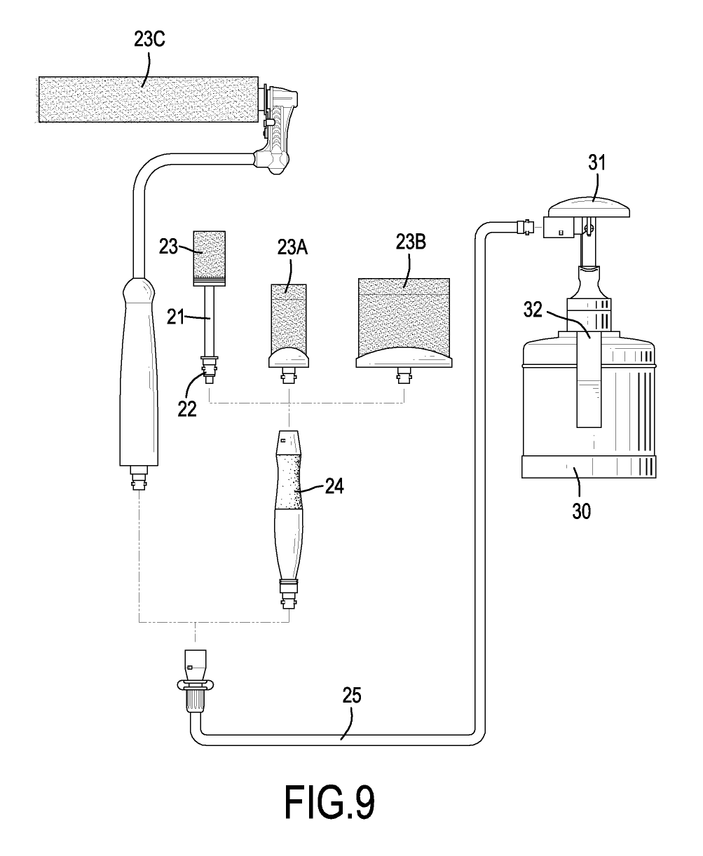

With reference to FIG. 9, in the third embodiment of the paint tool for manually supplying dye in accordance with the present invention, the elements and effects of the third embodiment are same with those of the first embodiment except the draft container 10 can be replaced with a pumping container 30. The pumping container 30 has a compressible head 31 and a clamper 32. The user can choose a suitable brush, assemble the suitable brush on the handle 24, assemble the handle 24 on the connecting tube 25, and combine the connecting tube 25 on the compressible head 31 in the described way. The clamper 32 is provided for clamping the pumping container 30 on the waist of the user. When the compressible head 31 is compressed, the paint dye in the pumping container 30 is drafted for painting work.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A paint tool for manually supplying dye comprising:
a draft container having
a flexible body provided for storing paint dye and having an opening defined on a top of the flexible body;
a draft head securely mounted on the flexible body, covering the opening, and having a locking hole defined through the draft head and communicating with the opening;
a unidirectional gate mounted in a bottom of the flexible body, having a first end disposed inside of the flexible body and a second end protruding through the bottom of the flexible body, and including
a first through hole defined in the first end of the unidirectional gate;
a second through hole defined in the second end of the unidirectional gate;
a receiving recess defined in the unidirectional gate and communicating with the first through hole and the second through hole;
a flexible valve disposed in the receiving recess, being a flat tapered tube, and having
a narrow end connected with the first through hole; and
a broad end being opposite to the narrow end and connected with the second through hole;
a paint assembly mounted on the draft head and having a brush head, the brush set including
a rod having a first end and a second end;
a connector disposed on the first end of the rod and selectively inserted into the locking hole;
a channel defined through the rod and the connector and communicating with the locking hole and the opening;
a brush head disposed on the second end of the rod and connected with the channel;
wherein when the flexible body is compressed, the paint dye in the flexible body flows through the opening, the locking hole and the channel to the brush head; when the flexible body is released, an air pressure in the flexible body is smaller than that of an external environment such that air is sucked into the flexible body from the second through hole in the unidirectional gate via the flexible valve and the first through hole, and the narrow end of the flexible valve is connected with the second through hole for preventing the paint dye from leaking.

2. The paint tool for manually supplying dye as claimed in claim 1, wherein the first through hole has an inner diameter being greater than an inner diameter of the second through hole, the receiving recess has an inner diameter being respectively greater than the inner diameters of the first through hole and the second through hole, and the broad end of the flexible valve has an outer edge tightly mounted on an inner surface of the receiving recess and has an inner diameter being greater than the inner diameter of the second through hole.

3. The paint tool for manually supplying dye as claimed in claim 2, wherein the locking hole includes
a first transversal hole; and
a second transversal hole located lower than the first transversal hole, communicating with the first transversal hole and having an inner space being greater than that of the first transversal hole; and
the connector is cylindrical and has two protrusions radially extending from the connector for being inserted into the locking hole, and the two protrusions are received in the first transversal hole, are rotated in the second transversal hole and are restricted by an inner surface of the first transversal hole for assembling the paint assembly on the draft head.

4. The paint tool for manually supplying dye as claimed in claim 3, wherein the paint assembly includes a handle having a first end and a second end, the first end of the handle has a locking hole defined in the handle and being the same with the locking hole in the draft head for assembling with the connector of the brush set, the second end of the handle has a connector disposed on the handle, and the handle has a channel defined through the handle.

5. The paint tool for manually supplying dye as claimed in claim 4, wherein the paint assembly includes a connecting tube having two ends, one end of the ends of the connecting tube has a locking hole defined in the connecting tube for assembling with the connector of the handle, and the other end of the ends of the connecting tube has a connector disposed on the connecting tube.

6. The paint tool for manually supplying dye as claimed in claim 5 further comprising a clamper mounted between the draft head and the flexible body and having
a ring sleeved on the flexible body; and
a sheet extending from the ring along an outer surface of the flexible body toward the bottom of the flexible body.

7. The paint tool for manually supplying dye as claimed in claim 1, wherein the paint assembly includes a connecting tube having two ends, one end of the ends of the connecting tube has a locking hole defined in the connecting tube for assembling with the connector of the brush set, and the other end of the ends of the connecting tube has a connector disposed on the connecting tube for being inserted into the locking hole in the draft head.

8. The paint tool for manually supplying dye as claimed in claim 1 further comprising a clamper mounted between the draft head and the flexible body and having
a ring sleeved on the flexible body; and
a sheet extending from the ring along an outer surface of the flexible body toward the bottom of the flexible body.

9. The paint tool for manually supplying dye as claimed in claim 1, wherein the locking hole includes
a first transversal hole; and
a second transversal hole located lower than the first transversal hole, communicating with the first transversal hole and having an inner space being greater than that of the first transversal hole; and
the connector is cylindrical and has two protrusions radially extending from the connector for being inserted into the locking hole, and the two protrusions are received in the first transversal hole, are rotated in the second transversal hole and are restricted by an inner surface of the first transversal hole for assembling the paint assembly on the draft head.

10. The paint tool for manually supplying dye as claimed in claim 9, wherein the paint assembly includes a connecting tube having two ends, one end of the ends of the connecting tube has a locking hole defined in the connecting tube for assembling with the connector of the brush set, and the other end of the ends of the connecting tube has a connector disposed on the connecting tube for being inserted into the locking hole in the draft head.

11. The paint tool for manually supplying dye as claimed in claim 9, wherein the paint assembly includes a handle having a first end and a second end, the first end of the handle has a locking hole defined in the handle and being the same with the locking hole in the draft head for assembling with the connector of the brush set, the second end of the handle has a connector disposed on the handle, and the handle has a channel defined through the handle.

12. The paint tool for manually supplying dye as claimed in claim 11, wherein the paint assembly includes a connecting tube having two ends, one end of the ends of the connecting tube has a locking hole defined in the connecting tube for assembling with the connector of the handle, and the other end of the ends of the connecting tube has a connector disposed on the connecting tube for being inserted into the locking hole in the draft head.

13. The paint tool for manually supplying dye as claimed in claim 1, wherein the paint assembly includes a handle having a first end and a second end, the first end of the handle has a locking hole defined in the handle and being the same with the locking hole in the draft head for assembling with the connector of the brush set, the second end of the handle has a connector disposed on the handle, and the handle has a channel defined through the handle.

14. The paint tool for manually supplying dye as claimed in claim 13, wherein the paint assembly includes a connecting tube having two ends, one end of the ends of the connecting tube has a locking hole defined in the connecting tube for assembling with the connector of the handle, and the other end of the ends of the connecting tube has a connector disposed on the connecting tube for being inserted into the locking hole in the draft head.
